(19) United States
(12) Patent Application Publication
(10) Pub. No.: US 2006/0018229 A1
(43) Pub. Date: Jan. 26, 2006

(54) Clock generation circuit and optical disk apparatus

(75) Inventor: Kimimasa Senba, Kanagawa (JP)

Correspondence Address: David R. Metzger;SONNENSCHEIN NATH & ROSENTHAL, Sears Tower, Wacker Drive Station, P.O. Box 061080, Chicago, IL, 60606-1080, US

(73) Assignee: Sony Corporation

(21) Appl. No.: 11/179,962

(22) Filed: Jul. 12, 2005

(30) Foreign Application Priority Data
Jul. 21, 2004 (JP) P2004-212577

(51) Int. Cl. G11B 5/09

(52) U.S. Cl. 369/59.1; 369/59.19; 369/47.48

(57) ABSTRACT

A wobble PLL circuit in an optical disk apparatus of the present invention is provided with a modulation and defect detector for measuring a fluctuation between adjoining cycles or a fluctuation of a one cycle interval included in an output signal of the phase comparator, and, if the measurement value exceeds a predetermined threshold value, assuming the measured value as a modulation portion or a defect and masking a feedback signal to a voltage controlled oscillator. As a result, a position of a phase window can be set accuracy, a normal phase comparison can be recognized, and a phase comparison result due to the defect can be masked accuracy, also.

### CROSS REFERENCES TO RELATED APPLICATIONS

The present invention contains subject matter related to Japanese Patent Application No. JP 2004-212577 filed in the Japanese Patent Office on Jul. 21, 2004, the entire contents of which being incorporated herein by reference.

### BACKGROUND OF THE INVENTION

1. Field of the Invention

The present invention relates to a clock generation circuit for generating a clock from a signal which is embedded another wave signal having a determined length into a reference carrier signal having a predetermined period, in particular relates to a clock generation circuit for generating a clock from information read from a disk recording medium in which a track is wobbled at a suitable wavelength, for example, and an optical disk apparatus including the same.

2. Description of the Related Art

There is known, for example, writable optical disks in which a track is wobbled at a suitable wavelength and a write clock is generated from a reproduction signal of the track. The wobbling of the track at the suitable wavelength is referred to a “wobbling”. The modulated reproduction signal is referred to a “wobbling signal”.

There is also known a writable optical disk among the disks, in which an address or other information is recorded by substituting a part of the wobble signal to other wave signal.

Specifically, when recording a data in the disk, it is necessary to provide a unit guiding the formation of a data track.

Then, a groove serving as a pregroove is formed in advance as shown in FIG. 1, and the groove or a land, which is a portion positioned between two adjacent grooves and having a trapezoid shape in a sectional plane, is used as a data track.

It is necessary to record the address information to enable a recording of a data at a predetermined position on the data track, but, the address information may be recorded by wobbling the groove.

In this way, the track for recording the data is formed as a pregroove in advance, and specifically, a sidewall of the pregroove is wobbled corresponding to the address information.

By forming the disk described above, the address can be read from the wobbling information obtained as reflection light at the recording operation or the reproduction operation, so the data can be record and reproduced at the predetermined position, without previously forming a pit data indicating the address on the track, for example.

In this way, by adding the address information as a wobbling groove, for example, it is unnecessary to provide discretely the address area on the track and record the address information as the pit data. As a result, the address area is not required, and a recording capacity for real data can be large.

Japanese Unexamined Patent Publication (Kokai) No. 2002-342941 discloses an optical disk apparatus for picking up information from a modulated wobble signal.

In the optical disk apparatus, when reproducing the information, a laser diode emits light and a photo detector receives the light reflected on a disk.

The photo detector PD, for example, as shown in FIG. 2, is divided into four regions of A, B, C and D. The respective signals from the divided photo detectors PD-A, PD-B, PD-C and PD-D are converted to a radio frequency (RF) signal, a tracking error (TE) signal, a focus error (FE) signal and other signals.

The RF signal is converted to a binary format via a read channel including an equalizer, a phase locked loop (PLL) circuit, an analog to digital converter and a Viterbi decoder.

The information recorded in the disk is reproduced by a demodulator and a decoder.

On the other hand, the signal from an external is modulated by an encoder and a modulator, and a laser is driven via a predetermined write system circuit by a laser driver to record a desired data in a disk.

The optical disk medium to be a target in such apparatus has the land and the groove on the disk. A timing signal is obtained by wobbling the shapes of the land and the groove.

Specifically, for example, the respective sum of the respective two signals divided into a track direction in the four-divided photo detector are subtracted, which is the same as the TE signal to obtain a signal in proportion to the wobble.

The signal is used to frequency generation (FG) information for a clock at the write operation and a spindle servo.

The wobbling signal is mainly used for picking up the timing signal, so normally a single frequency signal is written as the wobbling signal, and the modulation can be added to a part of the signal within a range not affecting to an operation of the PLL.

Such the modulated wobble signal is called as an “address in pregroove (ADIP)”.

As the general ADIP structure, for example, in DVD-RW which is a rewritable disk by a phase change recording system for a digital versatile disk (DVD), eight wobbles for 93 wobbles are used as shown in FIG. 3 and it is discriminated a synchronization (sync), data0 and data1 by a combination of the wave signals.

Also, in a blue-ray type disk, a minimum shift keying (MSK) mark is embedded in 56 wobbles and it is determined a synchronous pattern, data0 and data1 based on the position of the MSK mark.

The decoded result by a wobble decoder is established with synchronization in the respective units in the following stage synchronization block and in the respective word unit, and finally becomes the address information or other information.

On the other hand, the PLL circuit for the wobble synchronization, for picking up the timing signal from the wobble signal, has to be generated with so-called as a “detection window” so as to make a range for a phase comparison as large as possible when comparing the phases at the synchronization of the phase.

If the phase of the wobble signal is modulated, a normal signal may be not detected at the modulated portion due to a fluctuation of an amplitude or period of the wobble signal.

If trying the synchronizing of the phases while the wobble signal fluctuates, a lock state may not be maintained or the clock signal differing from the desirable frequency may be generated.

Then, Japanese Unexamined Patent Publication (kokai) No. 2001-319428 discloses an optical disk apparatus for performing a mask processing to a phase comparison result or a carrier signal in order to generate the detection window and detect the wobble signal.

The above technology is to detect an edge of the wobble signal, and adjust a phase detection window width based on the edge signal to mask the phase difference signal to be estimated abnormal.

### SUMMARY OF THE INVENTION

In such the edge comparison type PLL circuit, if the phase detection window is generated on the basis of the edge of the wobble, a position of the detection window is shifted in the case where the phase or frequency of the wobble per se is modulated, consequently, the normal phase comparison can not be performed.

A position of a modulation unit for recording an address can be estimated if once the phase of the wobble PLL is locked to be enable the decoding of the address, so that the phase comparison result of the modulation position may be masked on the basis of this information.

However, this method is not able to mask the phase comparison result due to cross-talk from an adjusting track or defect occurring suddenly in the modulation portion.

The defect is detected by a defect detection circuit then the processing for holding the wobble PLL is carried out, however, even in this case, a detection delays, so it is difficult to mask the phase comparison result in the initial defect.

The present invention is to provide an information detection circuit able to accuracy determine a position of a phase window, realize normal phase comparison and mask the phase comparison result due to the defect accuracy and a disk apparatus including the same.

According to an embodiment of the present invention, there is provided a clock generation circuit for generating a clock used for synchronization with a frequency of a carrier signal, from a signal generated by embedding another wave signal having a predetermined length into a reference carrier signal having a predetermined period, the clock generation circuit including: a sampling circuit for sampling the signal at a phase defined the generated clock; and a phase locked loop circuit. The phase locked loop circuit includes an oscillation circuit for generating a clock oscillating at a frequency corresponding to a phase comparison result and outputting it to the sampling circuit, a phase comparator for comparing phases of an output signal of the sampling circuit and the oscillation clock of the oscillation circuit and outputting the phase comparison result, and a detector for detecting a fluctuation of the output signal of the phase comparator and, if the fluctuation exceeding a set threshold value appears, masks a feedback signal which is the phase comparison result, to the oscillation circuit for that period.

According to an embodiment of the present invention, there is provided an optical disk apparatus having a wobble and modulating a part of the wobble to record a predetermined information, the optical disk apparatus including: a wobble data generation circuit for generating wobble data on the bases of a reproduction signal corresponding to the reflection light obtained by irradiating light to an optical disk; and a wobble clock generation circuit for having a phase locked loop circuit and generating a wobble clock on the bases of the wobble data generated by the wobble data generation circuit, wherein the wobble data generation circuit includes a sampling circuit for sampling the signal including the wobble data generated by the wobble data generation circuit at a phase defined the generated wobble clock, wherein the phase locked loop circuit includes an oscillation circuit for generating a clock oscillating at a frequency corresponding to a phase comparison result and outputting it to the sampling circuit, a phase comparator for comparing phases of a output signal of the sampling circuit and the oscillation clock of the oscillation circuit and outputting the phase comparison result, and a detector for detecting a fluctuation of the output signal of the phase comparator, and masking a feedback signal which is the phase comparison result to the oscillation circuit for that period, if the fluctuation exceeding a set threshold value appears.

Preferably, the detector measures a fluctuation between adjoining cycles or a fluctuation of a single cycle interval included in the output signal of the phase comparator. If the measurement value exceeds the predetermined threshold, the detector masks a feedback signal output from the phase comparator to the voltage controlled oscillator.

Preferably, in response to the predetermined signal, if the detection result to be masked is not obtained, the detector feedbacks the phase comparison result from the phase comparator to the voltage controlled oscillator and does not mask them.

Preferably, a part of the wobble is performed with an MSK modulation, and a masking duration of the detector is set to 4 wobbles cycle length.

Preferably, the predetermined threshold can be changed to a specific value.

According to the present invention, for example a wobble phase-locked loop (PLL) circuit in the optical disk apparatus has the detector for detecting the fluctuation included in the output signal from the phase comparator and, if the fluctuation exceeding the predetermined threshold appears, masks the feedback signal of the phase comparison result to the voltage controlled oscillator for a that period.

As a result, the fluctuation of the clock phase with respect to the wobble signal can be prevented.

According to the present invention, by measuring the fluctuation of the output from the phase comparator, an abnormal state can be detected at pulling-in the phase of the PLL and at locking the phase and the feedback signal can be masked to realize smooth pull-in at a pull-in operation and to prevent the fluctuation of the clock phase at a locking operation.

Further, if there is a cross-talk of the modulation signal from the adjusting track due to a tracking or a focus condition, the abnormal output signal of the phase comparator can be detected and masked.

Furthermore, with respect to the fluctuation of the wobble signal due to a defocus, when the defect detection circuit delays a detection, the output signal of the phase comparator can be masked rapidly to prevent the fluctuation of the clock phase in the wobble signal.

### BRIEF DESCRIPTION OF THE DRAWINGS

These features of embodiments of the present invention will be described in more detail with reference to the accompanying drawings, in which:

FIG. 1 is a view for describing a wobbling;

FIG. 2 is a view for describing a four-divided photo detector;

FIG. 3 is a view of a general ADIP configuration;

FIG. 4 is a view of a system configuration of an embodiment of an optical disk apparatus employing a clock generation circuit according to the present embodiment;

FIG. 5 is a view of an example of a modulation wave-signal of a wobble (in the case of an MSK modulation of a blue-lay disk);

FIG. 6 is a block view of an example of a specific configuration of a read channel circuit and a wobble PLL circuit that are included in a wobble reproduction system according to the present embodiment;

FIG. 7 is a circuit diagram of an example of a specific configuration of a modulation and a defect detection circuit according to the present embodiment;

FIG. 8 is a block view of an example of a noise level detector according to the present embodiment;

FIGS. 9A to 9U are timing charts for describing a mask processing in response to a phase error by the noise level detector according to the present embodiment, specifically the timing charts when detecting adjoining levels in the case of a noise width of 4WCLK69;

FIGS. 10A to 10U are timing charts when detecting the adjoining level in the case of a noise width of 3WCLK69;

FIGS. 11A to 11U are timing charts when detecting the adjoining level in the case of the noise width of 3WCLK69;

FIGS. 12A to 12U are timing charts when detecting the adjoining level in the case of the noise width of 3WCLK69, specifically the timing charts in the case that a detected difference of one-skipped adjoining level is large; and

FIGS. 13A to 13U are timing charts when detecting the adjoining level in the case of the noise width of 3WCLK69, specifically the timing charts in the case that one bit of noise detect enable value is set to low level (L).

### DESCRIPTION OF THE PREFERRED EMBODIMENTS

Preferred embodiments of the present invention will be described with reference to the accompanying drawings.

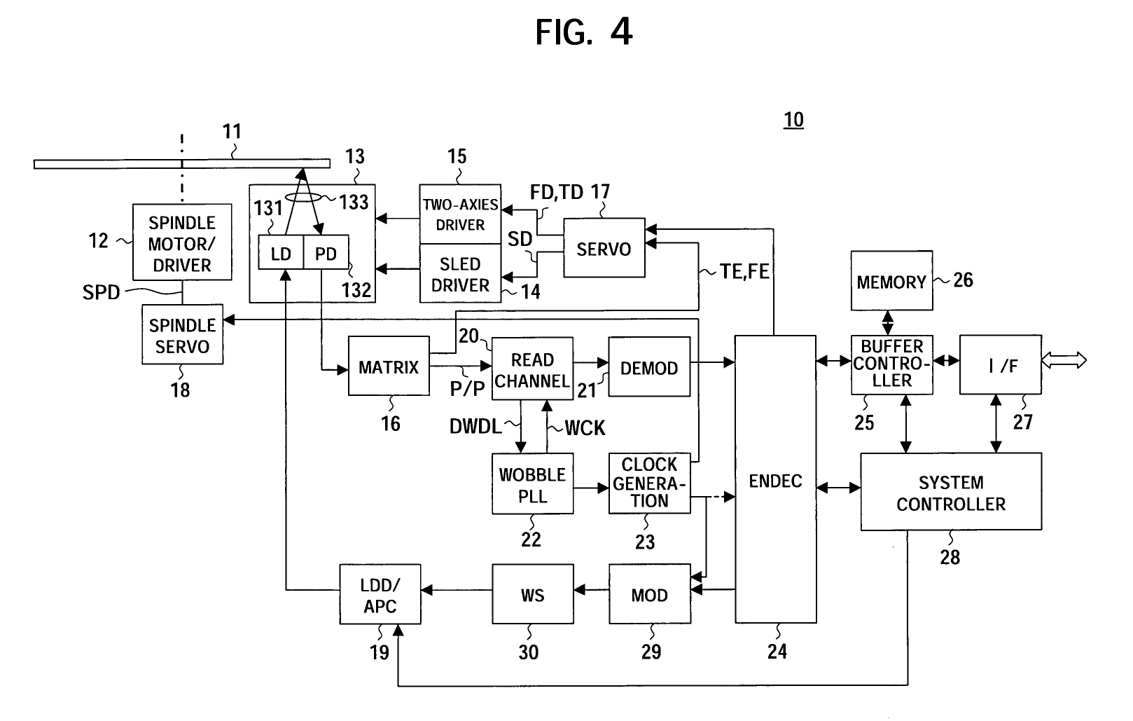

FIG. 4 is a view of a system configuration of an embodiment of an optical disk apparatus employing an information detection apparatus according to the present embodiment.

An optical disk apparatus 10 has a disk 11, a spindle motor and driver 12, an optical pick-up 13, a sled driver 14, a two-axies driver 15, a matrix circuit 16, a servo circuit 17, a spindle servo circuit 18, a laser driver and automatic power control circuit 19, a read channel circuit 20, an address demodulator (DEMOD) 21, a wobble PLL circuit 21, a clock generation circuit 23, an encode-decode circuit 24, a buffer controller 25, a buffer memory 26, an interface circuit (I/F) 27, a system controller 28, a modulation circuit (MOD) 29, and a write strategy circuit (WS) 30.

The disk 11 is mounted on a not shown turn table and rotated and driven by the spindle motor 12 at a recording operation and reproduction operation at a constant line velocity (CLV).

Then the optical pick-up 13 reads out a pit data recorded in the track on the disk 11 and an ADIP (address in pregroove) information recorded as the wobbling of the track. The pit recorded as a data on the track formed as a groove is so-called as a “phase change pit”, and the pit recorded in an embossed-pit area in the inner circumference side of the disk is so-called as an “embossed-pit”.

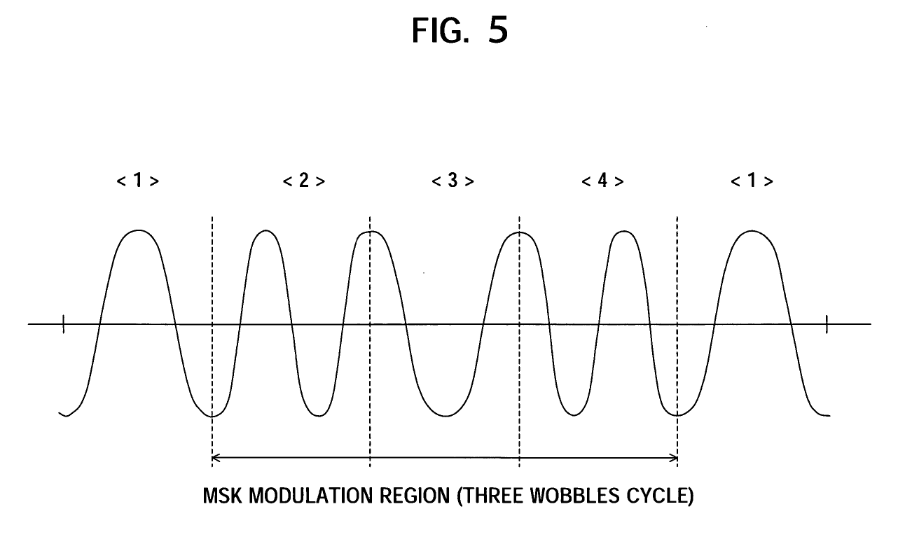

As a wobbling method, as shown in FIG. 5, another type of a wave-signal having one and a half times as much as the reference frequency and one and a half times as much as the reference period is embedded into a part of the wobble signal with 1/69 frequency of a data clock DCK with.

Specifically, in a continuing reference wave-signal indicating type 1 in FIG. 5, a minimum shift keying (MSK) mark having wave-signals of types 2 and 4 in the drawing, that is, one and a half times as much as the reference frequency, is embedded in this order. And a wave signal of type 3 is generated by inverting the phase of the reference wave-signal of type 1.

In the optical pick-up 13, a laser diode (LD) 131 as a laser beam source, a photo detector (PD) 132 for detecting reflection light from the disk 11, an objective lens 133 positioned at an output end of the laser beam, and a not shown optical system for irradiating the laser beam via the objective lens 133 to a disk recording side and guiding the reflection light to the photo detector 132 are formed.

Additionally, a monitor detector receiving a part of a beam output from the laser diode 131 is provided. The laser diode 131 outputs so-called blue laser with a wavelength of 405 nm, for example. And a numerical aperture (NA) of the optical system is 0.85.

The objective lens 133 is held by the two-axies driver 15 to be movable in a tracking direction or focus direction. The entire optical pick-up 13 is formed to be movable in a disk-radius direction by the sled driver 14. The laser diode 131 in the optical pick-up 13 is driven with laser irradiation in response to a drive signal (drive current) from the laser driver 19 to emit a laser beam.

Reflection light information from the disk 11 is detected by the photo detector 132, converted to an electric signal corresponding to an amount of received light, and applied to the matrix circuit 16 serving as a wobble data generation circuit.

Further, the servo circuit 17 generates a sled error signal obtained as a low-pass component in a tracking error signal TE and a sled drive signal SD on the basis of an access execution control signal from the system controller 28, and supplies the same to the sled driver 14.

The sled driver 14 drives a sled mechanism in response to the sled drive signal SD. The sled mechanism, omitted illustrations in the drawing, has a main shaft holding the optical pick-up 13, a sled motor, and a transmission gear. The sled driver 14 drives the sled motor in response to the sled drive signal SD to slide and move the optical pick-up 13.

The matrix circuit 16 is provided with a current-voltage conversion circuit and matrix operational amplification circuit which responses to an output current from a plurality of (for example, four) the light receiving elements as the photo detectors 132, and generates a necessary signal by a matrix operation processing.

The matrix circuit 16 generates, for example, a high frequency signal RF (reproduction data signal) corresponding to reproduction data, a focus error signal FE for a servo control, a tracking error signal TE, and other signals, and further generates a wobble data WBD as a signal according to the wobbling of the groove, namely a signal for detecting the wobbling.

The wobble data WBD output from the matrix circuit 16 and a push-pull signal P/P including the reproduction data signal are supplied to the read channel circuit 20 including a binary circuit, and the focus error signal FE and the tracking error signal TE are supplied to the servo circuit 17.

The servo circuit 17 generates focus, tracking, sled, or other types of servo drive signals from the focus error signal FE and the tracking error signal TE supplied from the matrix circuit 16, and makes the servo operation execute.

Namely, the servo circuit 17 generates a focus drive signal FD and a tracking drive signal TD, in response to the focus error signal FE and the tracking error signal TE, and supplies them to the two-axies driver 15.

The two-axies driver 15 drives a two-axies mechanism of a focus coil and a tracking coil in the optical pick-up 13.

As a result, the optical pick-up 13, the matrix circuit 16, the servo circuit 17, the two-axies driver 15, a tracking servo loop and a focus serve loop by the two-axies mechanism are formed.

The spindle servo circuit 18 controls the spindle motor 12 to rotate at a constant linear velocity. The spindle servo circuit 18 receives a wobble clock WCK generated in the wobble PLL circuit 22 and supplied via the clock generation circuit 21 to obtain a present (current) rotation speed information of the spindle motor 12, and compares the information with a predetermined CLV reference speed information to generate a spindle error signal SPE.

Since a reproduction clock as a reference in a decode operation generated by the PLL at the encode-decode circuit 24 is the present (current) rotation speed information of the spindle motor 12 in the data reproduction, the spindle servo circuit 18 can also compare the present information with the predetermined CLV reference speed information to generate the spindle error signal SPE.

The spindle servo circuit 18 supplies the spindle motor driver with the spindle drive signal generated in response to the spindle error signal SPE.

The spindle motor driver 12 applies a three-phase drive signal to the spindle motor in response to the spindle drive signal SPD to make the spindle motor 12 execute a rotation in constant linear velocity.

The spindle servo circuit 18 generates the spindle drive signal SPD in response to the spindle kick-brake control signal of the system controller 28, and makes the spindle motor driver 12 execute a start, stop, acceleration, deceleration or other operation of the spindle motor.

The laser driver 19 supplies the laser diode 131 of the optical pick-up 13 with the laser drive pulse supplied as write data WDATA to make the laser diode 131 emits a laser beam. Consequently, a pit (phase change pit) corresponding to the recording data is formed in the disk 11.

The auto power control (APC) circuit 19 monitors a laser output power by using an output signal of the monitor detector and controls the laser output power to make it constantly without depending on an ambient temperature. The target value of the laser output power is supplied by the system controller 28. The laser driver is controlled so as to make the laser output power level the target value.

The read channel circuit 20 detects the wobble signal on the bases of the push-pull signal P/P from the matrix circuit 16, samples the wobble signal detected by the wobble clock of the wobble PLL circuit 22 by using the wobble clock of the wobble PLL circuit 22, converts the sampled wobble signal to binary format, and outputs the digital wobble reproduction signal DWBL to the address demodulator 21 and the wobble PLL circuit 22.

The address demodulator 21 detects the modulation signal in the digital wobble reproduction signal DWBL of the read channel circuit 20, address-demodulates the result, and outputs the demodulated signal to the address decoder unit in the encode-decode circuit 24.

The wobble PLL circuit 22 serving as the wobble clock generation circuit generates the wobble clock WCK for synchronization with the frequency of the carrier signal of the reference predetermined frequency (T) on the bases of the wobble signal DWBL of the read channel circuit 20, and supplies the wobble clock WCK to the read channel circuit 20 and the clock generation circuit 23.

The clock generation circuit 23 generates a modulation clock from the wobble clock WCK of the wobble PLL circuit 22, and supplies the same to the modulator 29.

In the clock generation circuit 23 the wobble clock WCK from the wobble PLL circuit 22 is supplied to the spindle servo circuit 18.

The wobble PLL circuit 22 serving as a wobble clock generation circuit basically compares the phases of an oscillation output signal of a VCO (voltage-controlled oscillator, in the PLL) and the wobble signal DWBL on the phase comparator. The wobble PLL circuit 22 according to the present embodiment has a detector for detecting the fluctuation of the output signal from the phase comparator, and, if the fluctuation exceeding the predetermined threshold appears, masks a feedback signal of the phase comparison result to the VCO for that period to prevent the fluctuation of the clock phase to the wobble signal.

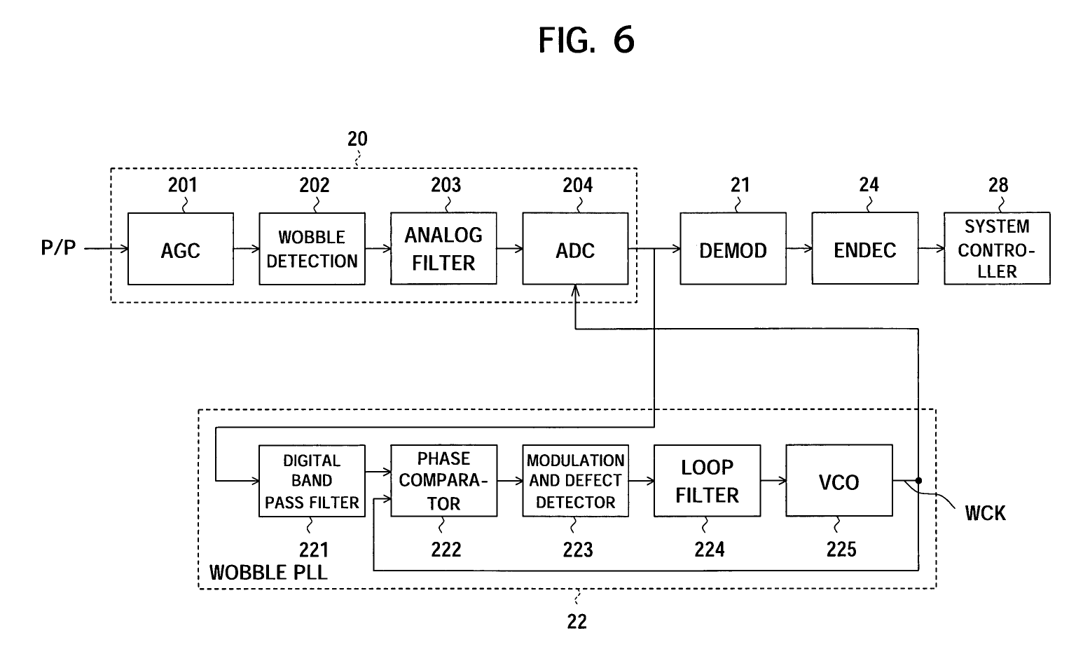

FIG. 6 is a block view of an example of a specific configuration of the read channel circuit 20 and the wobble PLL circuit 22 that are included in the wobble reproduction system according to the present embodiment.

The read channel circuit 20 has an automatic gain control (AGC) circuit 201, a wobble detection circuit 202, an analog filter 203, and an analog-to-digital conversion (ADC) circuit 204.

The AGC circuit 201 adjusts the amplitude of the push-pull signal P/P of the matrix circuit 16, and outputs the result to the wobble detection circuit 202.

The wobble detection circuit 202 extracts the wobble signal in the push-pull signal adjusted with the amplitude by the AGC circuit 201, and supplies the result to the analog filter 203.

The analog filter 203 eliminates the unnecessary low-pass and high-pass signal components in the wobble signal extracted by the wobble detection circuit 202, and supplies the ADC circuit 204 with the result as the wobble reproduction signal.

The ADC circuit 204 converts the wobble reproduction signal to the digital signal, and outputs the result to the address demodulator 21 and the wobble PLL circuit 22.

In the conversion processing by the ADC circuit 204, since it is necessary to match a sampling phase to the normal state, the wobble PLL circuit 22 may be demanded for this purpose, so the ADC circuit 204 samples the wobble reproduction signal of the analog filter 203 by using the wobble clock WCK of the wobble PLL circuit 22.

The wobble PLL circuit 22 has a digital band pass filter 221, a phase comparator 222, a modulation and defect detector (hereinafter, also referred to a detector) 223, a loop filter 224, and a VCO 225.

The digital band pass filter 221 eliminates an unnecessary signal component for comparing phases of the phase comparator 222, and outputs the result to the phase comparator 222.

The phase comparator 222 compares phases of the digital wobble reproduction signal of the digital band pass filter 221 and the wobble clock WCK serving as the oscillation output of the VCO 225, and outputs the phase comparison result as a signal S222 to the detector 223.

The detector 223 masks the output signal to the loop filter 224 if detecting a modulation portion, or abnormal state due to defect in the phase comparison result of the phase comparator 222.

The loop filter 224 feedbacks a normal phase error data of the phase comparator 222 when the detector 223 does not mask, and supplies the VCO 225 with the control voltage according to the phase error data.

The VCO 225 oscillates at the frequency corresponding to the control voltage of the loop filter 224, and supplies the phase comparator 222 and the ADC circuit 214 of the read channel circuit 21 with the oscillated output signal as the wobble clock WCK.

FIG. 7 is a circuit diagram of an example of a specific configuration of the modulation and defect detector 223 according to the present embodiment.

The modulation and defect detector 223 in FIG. 7 has latch circuits 2231, 2232 and 2233, a first noise level detector 2234, a second noise level detector 2235, third noise level detector 2236, a two-input AND gate including a single negative input terminal 2237, a two-input OR gate 2238, a counter 2239, and switch circuits 2240 and 2241.

The latch circuit 2231 synchronizes a phase comparison result signal S222 of the phase comparator 222, namely a signal NM0 in which six-bit of an input phase difference error INERR exists in a node ND0, to the clock CLK, latches the result, and outputs the result as a six-bit signal NM1 to a node ND1.

The latch circuit 2232 synchronizes the signal NM1 appeared in the node ND1 with the clock signal CLK, latches the result and outputs the result as a six bits of a signal NM2 to a node ND2.

The latch circuit 2233 synchronizes the output signal of the switch circuit 2241 with the clock signal CLK, latches the result, and supplies the following state of the loop filter 224 with the output signal “maskout” of the detector 223.

Note that, the latch circuits 2231 to 2233 are reset by a reset signal RST.

The first noise level detector 2234 subtracts the signal NM2 latched by the latch circuit 2232 and appeared in the node ND2 and the signal NM1 latched by the latch circuit 2231 and appeared in the node ND1, compares the absolute value of the subtraction result with for example four bits of determined threshold value NOIDETLVL set to a not shown resistor (for example set to 15), and outputs a signal NM12 at high level in the case that the absolute value is larger than the threshold NOIDETLVL or at low level in the case that the absolute value is smaller than the threshold NOIDETLVL to the one input terminal of the OR gate 2238.

The first noise level detector 2234 detects the fluctuation (difference) between the adjoining cycles output from the phase comparator.

The second noise level detector 2235 subtracts the signal NM2 latched by the latch circuit 2232 and appeared in the node ND2 and the signal NM0 appeared in the node ND0 of an input terminal side, compares the absolute value of the subtraction result with, for example, four bits of the determined threshold value NOIDETLVL set to a not shown resistor (for example set to 15), and outputs a signal NM20 at high level in the case that the absolute value is larger than the threshold NOIDETLVL to a positive input terminal of the AND data 2237, or at low level in the case that the absolute value is smaller than the threshold NOIDETLVL to a positive input terminal of the AND data 2237.

The second noise level detector 2235 detects the fluctuation of a single cycle interval output from the phase comparator.

The third noise level detector 2236 subtracts the signal NM1 latched by the latch circuit 2231 and appeared in the node ND1 and the signal NM0 appeared in the node ND0, compares the absolute value of the subtraction result with, for example, four bits of the determined threshold value NOIDETLVL set to a not shown resistor (for example set to 15), and outputs a signal NM10 at high level to mask the phase comparison result to a negative input terminal of the AND gate 2237 in the case where the absolute value is larger than the threshold NOIDETLVL or at low level not to mask the phase comparison result to a negative input terminal of the AND gate 2237 in the case where the absolute value is smaller than the threshold NOIDETLVL.

The third noise level detector 2236 detects the fluctuation between the adjoining cycles output from the phase comparator.

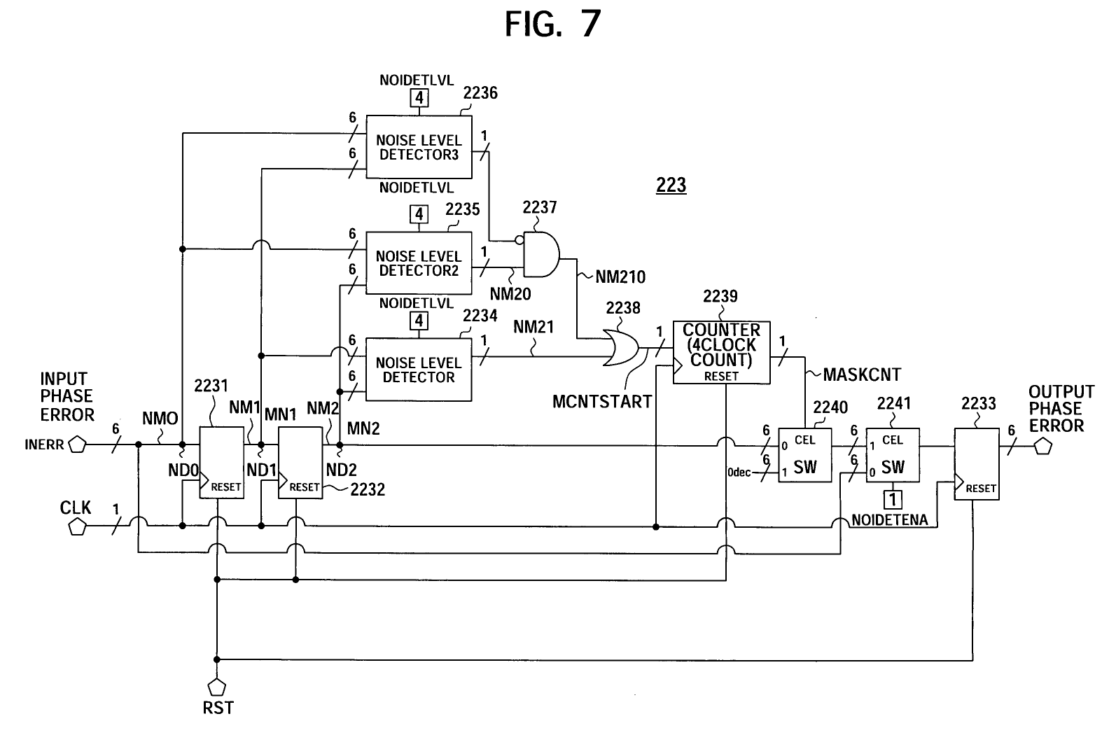

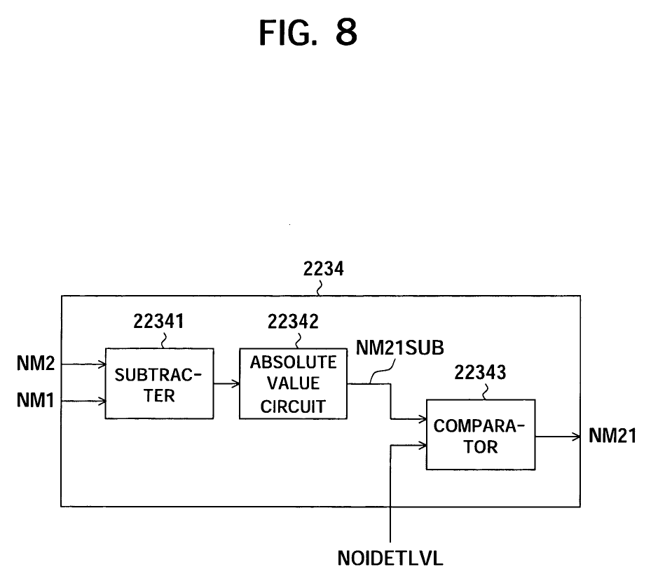

FIG. 8 is a block view of an example of a configuration of the noise level detector according to the present embodiment. Here, the first noise level detector 2234 will be described as an example, the second and third noise level detector have similarly configuration.

The noise level detector 2234 has a subtracter 22341 performing a subtraction operation of the signals NM2 and NM1, an absolute value circuit 22343 preparing the absolute value of the subtraction result of the subtracter 22341, and a comparator 22342 comparing the absolute value NM21SUB of the absolute value circuit 22342 and the four bits of the determined threshold value NOIDETLVL (for example, set to 15) set to a not shown resistor and outputting the comparison result as the low level or high level signal NM21.

The AND gate 2237 calculates an AND operation of the output signal NM20 of the second noise level detector 2235 and the output signal NM10 of the third noise level detector 2236, and outputs the result as a signal NM210 to another input terminal of the OR gate 2238.

The AND gate 2237 outputs the signal NM210 at a high level to another input terminal of the OR gate 2238 so as to mask the phase comparison result when the second noise level detector 2235 detects the noise level, the output signal NM20 is input at a high level, and the output signal NM10 of the third noise level detector 2236 is low level.

On the other hand, the AND gate 2237 outputs the signal NM210 at a low level to another input terminal of the OR gate 2238 not to mask the phase comparison result when the second noise level detector 2235 detects the noise level, the output signal NM20 is input at a high level, and the output signal NM10 of the third noise level detector 2236 detects the noise level at a high level.

The OR gate 2238 outputs a mask counter start signal MCNTSTART to a counter 2239 while the output signal NM21 of the first noise level detector 2234 is high level and/or the output signal NM210 of the AND gate 2237 is high level.

The counter 2239 receives the mask counter start signal MCNTSTART at high level, counts up for example from a point that the mask counter start signal MCNTSTART is switched to low level, and outputs the count value MASKCNT to the switch circuit 2240.

Then the counter 2239 resets in the case where the count value is larger than four.

The switch circuit 2240 outputs the signal NM3 in the node ND2 as a signal MASKOUT0 to the switch circuit 2241 in the case where the output value MASKCNT of the counter 2239 is zero. The switch circuit 2240 masks the signal NM3 of the node ND2 in the case where the output value MASKCNT of the counter 2239 is other than 0, and outputs zero as a signal MASKOUT0 to the switch circuit 2241.

The switch circuit 2241 outputs the output signal of the switch circuit 2240 as a signal MASKOUT to the latch circuit 2233 in the case where, for example, one bit of a noise detect enable value NOIDETENA set to a not shown resistor is set to high level (H).

On the other hand, the switch circuit 2241 selects a signal NM0 of the input phase difference error INERR in the case where, for example, one bit of the noise detect enable value NOIDETENA set to a not shown resistor is set to low level (L) and output it as the signal MASKOUT to the latch circuit 2233.

The modulation and defect detector 223 having such configuration measures the fluctuation between the adjoining cycles or the fluctuation of one cycle interval in the output signal from the phase comparator 222, assumes the result as a modulation region or defect if the result exceeds the determined threshold value NOIDETLVL, and masks the feedback signal output from the phase comparator to the VCO.

The determined threshold value NOIDETLVL can be set to any value by a resistor.

A length of the modulation region of the wobble in the blue-lay disk is determined at three wobbles cycle length in terms of a format, so that the modulation region may be masked by using four wobbles cycle length considering the phase shift.

It there is defect, the defect may be also masked by using at least four wobbles cycle length considering a term from detection by the defect detection circuit to a feedback to the wobble PLL.

The configuration and operation of the modulation and defect detector 223 according to the present embodiment is described above. Below, the operations of the encode-decode circuit 24 to the write strategy circuit 30 in FIG. 4 will be described, further the operation of the wobble reproduction system, mainly the operation of the modulation and defect detector 223 will be described with reference to drawings.

The encode-decode circuit 24 has a function unit as a decoder in a reproducing operation and a function unit as an encoder in a recording operation. The encode-decode circuit 24 performs demodulation of a run-length limited code, error correction, deinterleave, or other processing as a decode processing at a reproduction operation to obtain reproduction data.

The encode-decode circuit 24 generates a reproduction clock in synchronization with the reproduction data signal by the PLL processing, and executes a predetermined decode processing on the basis of the reproduction clock during reproducing.

At the reproduction, the encode-decode circuit 24 stores the decoded data via the buffer controller 25 in the buffer memory 26.

As a reproduction output signal from the optical disk apparatus 10, the data buffered in the buffering memory 26 is read, transferred, and output.

The interface circuit 27 is connected to a not shown external host computer, and communicates with recorded data, reproduction data, or other command, from and to the host computer.

At the reproduction, the reproduction data decoded and stored in the buffer memory 26 is output via the interface circuit 27 to the host computer.

Note that, a read command, a write command, or other signal from the host computer is supplied to the system controller 28 via the interface circuit.

On the other hand, at a recording operation, the recorded data is transferred from a not shown host computer. The recorded data is transmitted from the interface circuit 27 to the buffer memory 26 and buffered.

In this case, the encode-decode circuit 24 executes addition of the error correction code, addition of the interleave or sub-code, and encoding the recording data to the disk 100 as an encode processing of the buffered recording data.

The encode clock to be a reference clock for the encode processing at the recording is generated in the clock generation circuit 23. And the encode-decode circuit 24 performs the encode processing by using the encode clock.

The recoding data generated by the encode processing in the encode-decode circuit 24 is modulated by the modulator 29, performed with a wave signal adjustment processing by the write strategy circuit 30, and transmitted to the laser driver 19 as a laser driver pulse (write data WDATA).

In the write strategy circuit 30, record compensation, namely fine adjustment of the suitable recording power with respect to the property of the recording layer, spot-shape of the laser beam, or recording linear velocity, and adjustment of a laser drive pulse shape is performed.

The various operations of the servo system and the recording reproduction system are controlled by the system controller 28 included in a micro computer.

The system controller 28 executes the various processing in response to commands from a not shown host computer. In the case that a read command requesting a transfer of a certain data recoded in the disk 11 is supplied from the host computer, the system controller 28 performs seek operation control with the instructed address as a target.

Namely, a command is given to the servo circuit 17 to make the servo circuit 17 execute an access operation of the optical pick-up 13 in which the address instructed by the seek command is a target. Then, the operation and control demanded for transferring data of an instructed data interval to the host computer is performed. That is, a data read, a decoding and a buffering from the disk 11 is performed, and the demanded data are transferred.

In response to a track jump command of the system controller 28, the tracking servo loop is turned off, the jump drive signal is output to the two-axies driver 15 to make it execute a track jump operation.

When a write command is output from a hot shown host computer, the system controller 28 makes the optical pick-up 13 move to an address to be written.

Then, the encode-decode circuit 24 performs an encode processing to data transferred from the host computer.

Then, the write data WDATA from the write strategy circuit 30 is supplied to the laser driver 19 to execute a recording.

On the other hand, in the above description, the optical disk apparatus 10 connected to the host computer is descried, but, the optical disk according to the present invention may not be connected to the host computer.

In that case, an operation unit or display unit will be provided, or a configuration of the interface circuit for inputting or outputting data differs from that in FIG. 4. Namely, the recording and the reproduction may be performed by an operation from a user and a terminal portion for inputting or outputting various data may be formed. It can be considered with various configurations, for example, examples of application for a recording apparatus or a reproduction apparatus.

Next, an operation of the wobble reproducing system according to the present embodiment, mainly the operation of the modulation and defect detector 223 will be described with reference to timing charts.

In the present embodiment, as a wobbling method, as shown in FIG. 5, another type wave signal (having one and a half times as much as the reference frequency, and one and a half times as much as the reference period) is embedded into a part of the wobble signal as a reference having 1/69 frequency of a data clock DCK.

Specifically, the types 2 and 4 of wave signals, namely the MSK mark having one and a half times as much as frequency of the reference wave signal, is embedded in this order in the reference wave signal indicated by continuing type 1 in FIG. 5. The wave signal of type 3 has a reversed phase of the reference wave signal 1.

A method of detecting the existence of the wave signals of types 2, 3 and 4 and the timing thereof in noise will be described.

The push-pull signal P/P including the wobble signal read out from the optical pick-up 13 and generated by the matrix circuit 16 is input to the read channel circuit 20.

In the read channel circuit 20, the input push-pull signal P/P is adjusted with the amplitude by the AGC circuit 201, the wobble signal is extracted by the wobble detection circuit 202 and input to the analog filter 203.

The reproduction signal eliminated with the unnecessary low-pass and high-pass signal components by the analog filter 203 is input to the ADC 204.

In this process, the sampling phase of the ADC circuit 204 may have to be matched with normal state, so that the wobble PLL circuit 22 is demanded.

The output signal of the ADC circuit 204 is input to the address demodulator 21. The address demodulator 21 detects the modulation signal of the input wobble signal and demodulates the address. The following state of the address demodulator 24 decodes the address from the demodulator data and outputs the result to the controller 28.

The output signal of the ADC circuit 204 is also input to the wobble PLL circuit 22.

In the wobble PLL circuit 22, the signal component unnecessary for the phase comparison is eliminated by using the digital band pass filter 221 and input to the phase comparator 222. The phase comparison result of the phase comparator 222 is input to the modulation and defect detector 223. If the abnormal state due to a modulation portion or defect is detected, the output signal to the loop filter 224 is masked.

Therefore, normal phase difference data is only feedbacked to the loop filter and the unnecessary noise insertion to the VCO 225 can be prevented.

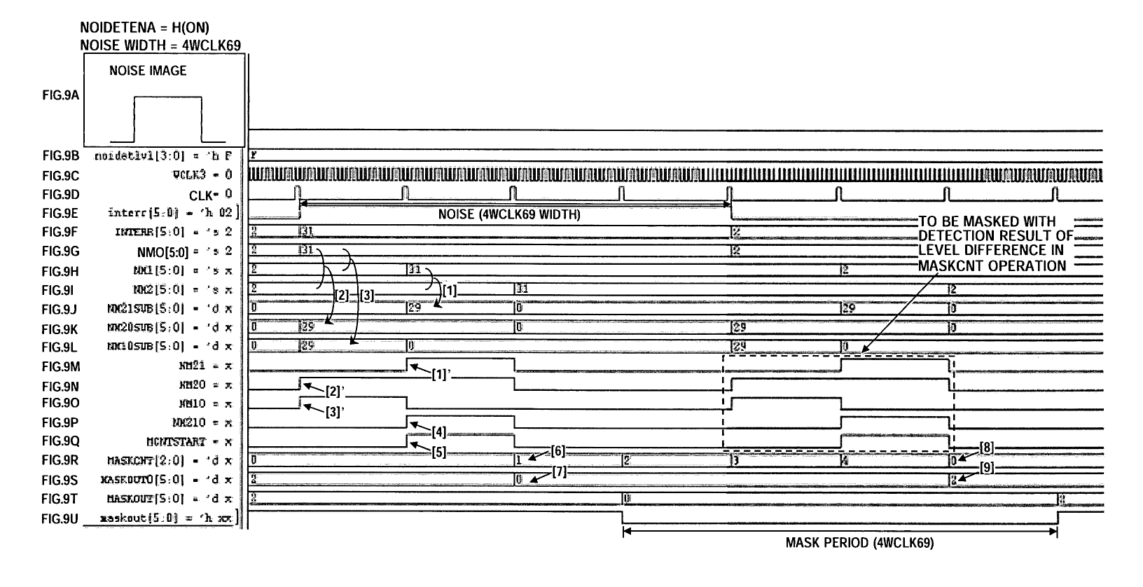

Here, with reference to the timing chart of FIGS. 9A to 9U, the switch circuit 2241 outputs the output signal of the switch circuit 2240 as a signal MADKOUT to the latch circuit 2233 in the case that the noise width is 4WCKL69 and the noise detect enable signal NOIDETENA is set to the high level (H) in the modulation and defect detector 223.

The noise detect level NOIDETLVL is set to 15 and the INERR difference is set to 29 in a plus direction.

The noise is assumed as a rectangle pulse shape shown in FIG. 9A.

(1): as shown in FIGS. 9H to 9J, in the first noise level detector 2234, a detection of a difference of the adjoining levels between the signal NM1 of the node ND1 and the signal NM2 of the node ND2 is performed.

In this example, the NM1 is set to 31 and the NM2 is set to 2, so that the subtraction result becomes 29. This is larger than the predetermined noise detect level NOIDETLVL of 15.

(1)′: as a result, as shown in FIG. 9M, the output signal NM21 of the first noise level detector 2234 becomes a high level.

(2): as shown in FIGS. 9G to 9K, in the second noise level detector 2235, a detection of a difference of a one-skipped adjoining level of the signal NM2 of the node ND2 and the signal NM0 of the node ND0 is performed.

In this example, the NM0 is set to 31 and the NM2 is set to 2, so that the subtraction result becomes 29. This is larger than the predetermined noise detect level NOIDETLVL of 15.

(2)′: as a result, as shown in FIG. 9N, the output signal NM20 of the second noise level detector 2235 becomes the high level.

(3): as shown in FIGS. 9G to 9L, in the third noise level detector 2236, a detection of a detection control level of the difference of the one-skipped adjoining level of the signal NM1 of the node ND1 and the signal NM0 of the node ND0 is performed.

In this example, the NM0 is set to 31 and the NM1 is set to 2, so that the subtraction result becomes 29. This is larger than the predetermined noise detect level NOIDETLVL of 15.

(3)′: as a result, as shown in FIG. 90, the output signal NM0 of the third noise level detector 2235 becomes the high level.

As a result, as shown in FIG. 9P, the output signal NM210 of the AND gate 2237 becomes the low level, and the output signal NM20 of the second noise level detector 2235 becomes a high level. Namely, the noise level detection result of the detection of the difference of the one-skipped adjoining levels is cancelled.

(4): as shown in FIG. 90, the output signal NM10 of the third noise level detector 2236 becomes the low level after controlling the detection of the difference of the one-skipped adjoining levels, so the output signal NM210 of the AND gate 2237 is switched to the high level as shown in FIG. 9P.

(5): as shown in FIGS. 9M to 9Q, the signal NM21 and the signal NM210 are the high level, so that the output signal MCNTSTART of the OR gate 2238 becomes the high level.

(6): as a result, as shown in FIG. 9R, the counter 2239 starts count-up.

(7): accompanying with this, as shown in FIG. 9S, the switch circuit 2240 masks the output of the signal NM2 and outputs the signal MASKOUT0 of zero.

Therefore, as shown in FIGS. 9T and 9U, the output signal MASKOUT of the switch circuit 2241 and the output signal of the latch circuit 2233, namely the output signal “maskout” of the detector 231, are held at zero. That is, it is assumed that the abnormal state due to the modulation portion or defect is detected, and the phase comparison result of the phase comparator 222 is masked and is not output to the loop filter 224.

(8): then, as shown in FIG. 9R, at the point that the count value of the counter 2239 is larger than 4, the counter 2239 is reset to stop a count operation.

As a result, as shown in FIGS. 9S to 9U, the switch circuit 2240 selects the signal NM2 (value2) of the node ND2 to output the signal MASKOUT0 to the switch circuit 2241. The output signal “maskout” of the detector 231 becomes the value2 through the switch circuit 2241 and the latch circuit 2233 to output it to the loop filter 224.

Consequently, only a normal phase error data is feedbacked to the loop filter, and an unnecessary noise insertion to the VCO 225 can be prevented.

FIGS. 10A to 10U are timing charts in detecting the adjoining levels when the noise width is 3WCLK69.

Specifically processing is similar to the operation when the noise width is 4WCLK69 described with reference to FIGS. 9A to 9U, so the description is omitted.

FIGS. 11A to 11U are timing charts in detecting the adjoining levels when the noise width is 3WCLK69.

A noise image in this case is a step-wise pulses as shown in FIG. 11A.

(1): as shown in FIGS. 11H to 11J, in the first noise level detector 2234, the detection of the difference of the adjoining level between the signal NM1 of the node ND1 and the signal NM2 of the node ND2 is performed.

In this example, the NM1 is set to 12 and the NM2 is set to 2, so that the subtraction result becomes 10. This is smaller than the predetermined noise detection level NOIDETLVL of 15.

(1)′: as a result, as shown in FIG. 11M, the output signal NM21 of the first noise level detector 2234 becomes the low level.

(2): as shown in FIGS. 11G to 11K, in the second noise level detector 2235, the detection of the difference of the one-skipped adjoining level of the signal NM2 of the node ND2 and the signal NM0 of the node ND0 is performed.

In this example, the NM0 is set to 20 and the NM2 is set to 2, so that the subtraction result becomes 18. This is larger than the predetermined noise detect level NOIDETLVL of 15.

(2)′: as a result, as shown in FIG. 11N, the output signal NM20 of the second noise level detector 2235 becomes the high level.

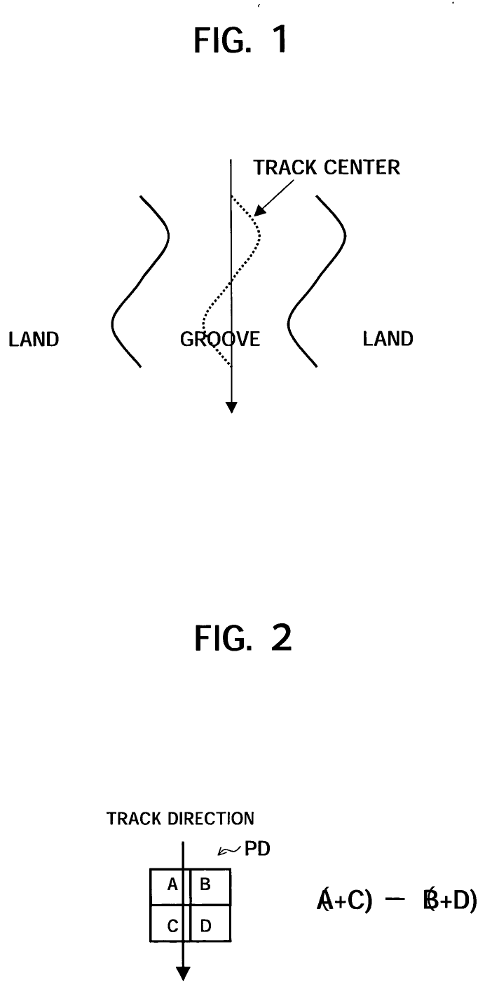

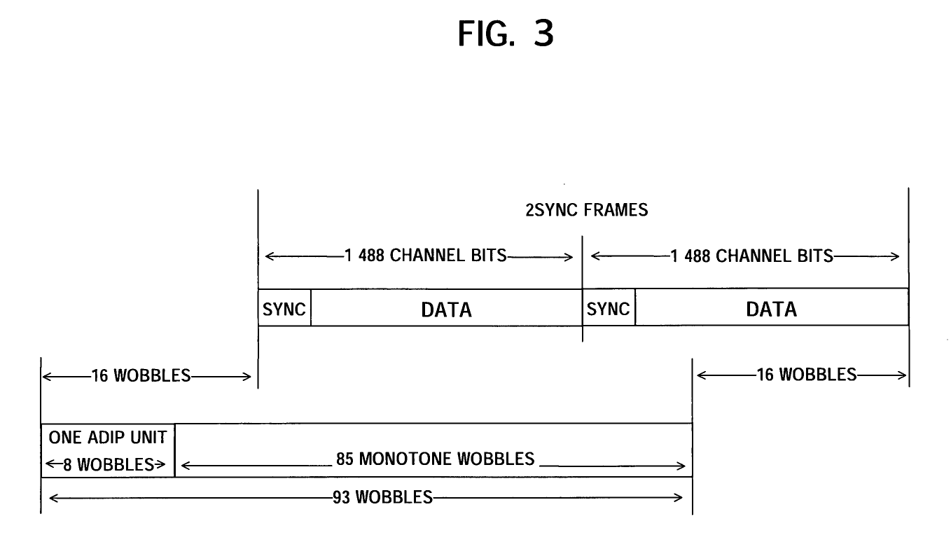

(3): as shown in FIGS. 11G to 1L, in the third noise level detector 2236, the detection of the detection control level of the difference of the one-skipped adjoining level of the signal NM1 of the node ND1 and the signal NM0 of the node ND0 is performed.

In this example, the NM0 is set to 20 and the NM1 is set to 12, so that the subtraction result becomes 8. This is smaller than the predetermined noise detection level NOIDETLVL of 15.

(3)′: as a result, as shown in FIG. 110, the output signal NM10 of the third noise level detector 2236 becomes the low level.

(4): consequently, as shown in FIG. 11P, the output signal NM210 of the AND gate 2237 becomes the high level. As a result, the output signal NM20 of the second noise level detector 2235 is the high level, namely, the noise level detection result of the difference of the one-skipped adjoining level makes effective.

(5): then, as shown in FIGS. 11M to 11Q, the signal NM21 or the signal NM210 is the high level, so that the output signal MCNTSTART of the OR gate 2238 becomes the high level.

(6): as a result, as shown in FIG. 11R, the counter 2239 starts a count-up.

(7): accompanying with this, as shown in FIG. 11S, the switch circuit 2240 masks the output signal of the signal NM2 and outputs the signal MASKOUT0 of zero.

Therefore, as shown in FIGS. 11T and 11U, the output signal MASKOUT of the switch circuit 2241 and the output signal of the latch circuit 2233, namely the output signal “maskout” of the detector 231, are held at zero. That is, it is assumed that the abnormal state due to the modulation portion or defect is detected and the phase comparison result of the phase comparator 222 is masked and is not output to the loop filter 224.

Then, as shown in FIG. 11R, at the point that the count value of the counter 2239 is larger than 4, the counter 2239 is reset to stop the count operation.

As a result, as shown in FIGS. 11S to 11U, the switch circuit 2240 selects the signal NM2 (value2) of the node ND2 to output the signal MASKOUT0 to the switch circuit 2241. The output signal “maskout” of the detector 231 becomes the value2 through the switch circuit 2241 and the latch circuit 2233, and output to the loop filter 224.

Consequently, only a normal phase error data is feedbacked to the loop filter, and the unnecessary noise insertion to the VCO 225 can be prevented.

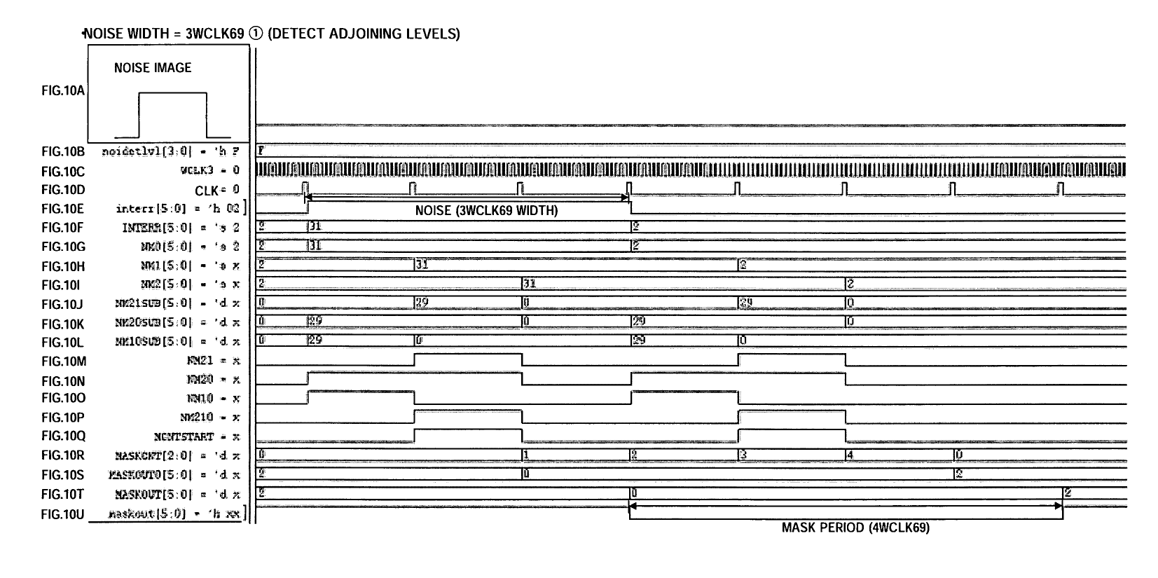

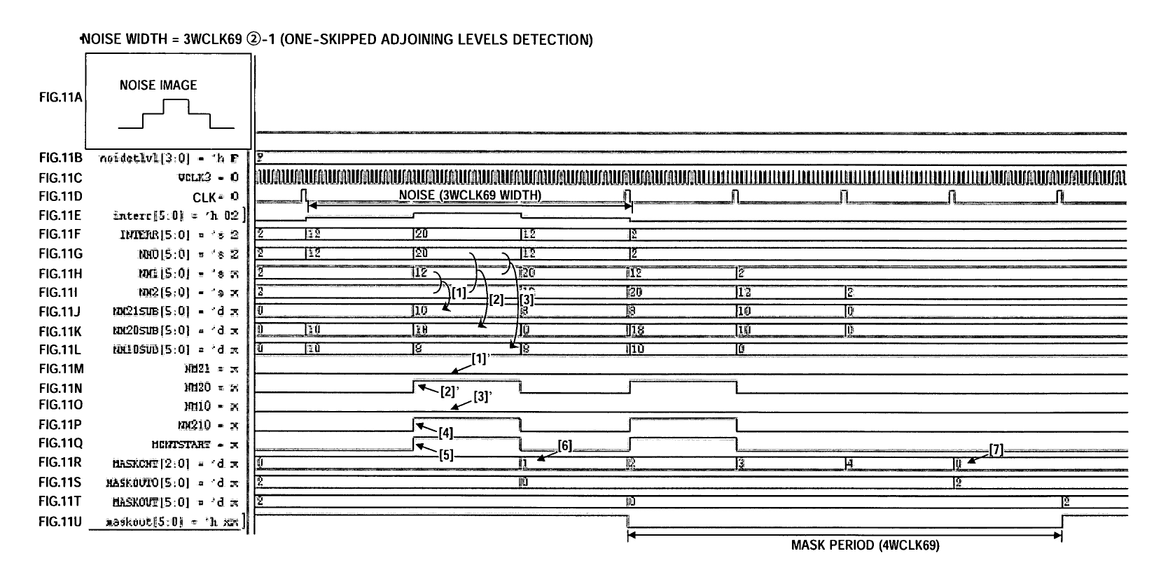

FIGS. 12A to 12U are timing charts in detecting the adjoining levels when the noise width is 3WCLK69, specifically the timing chart in the case where the detected level difference of the one-skipped adjoining levels is large.

The noise image in this case is, as shown in FIG. 12E, the step-wise pulses.

In this case, as shown in FIG. 12E, when a level difference of (2) is larger than the noise detect level NOIDETLVL, the mask start delays one timing.

The level difference of (1) and (2) has the following interrelationship:
(2) is large and (1) is small;
(1) is large and (2) is small.

Therefore, when the level difference of (2) is large, it is assumed that it is similar to the rectangle noise wave. So it is not disadvantage that the (1) is not masked.

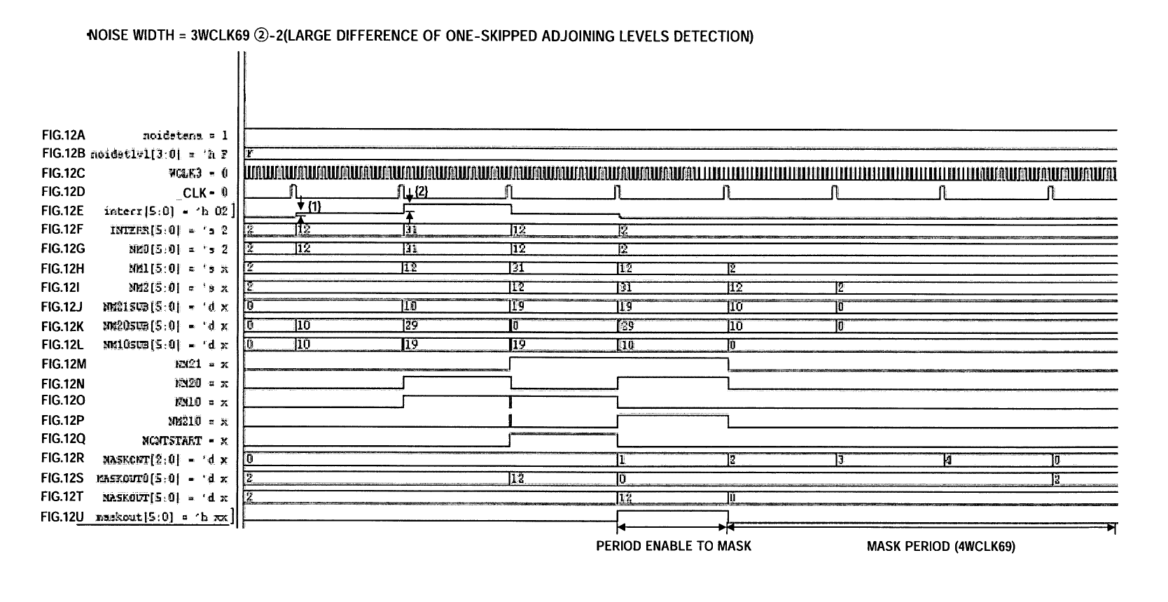

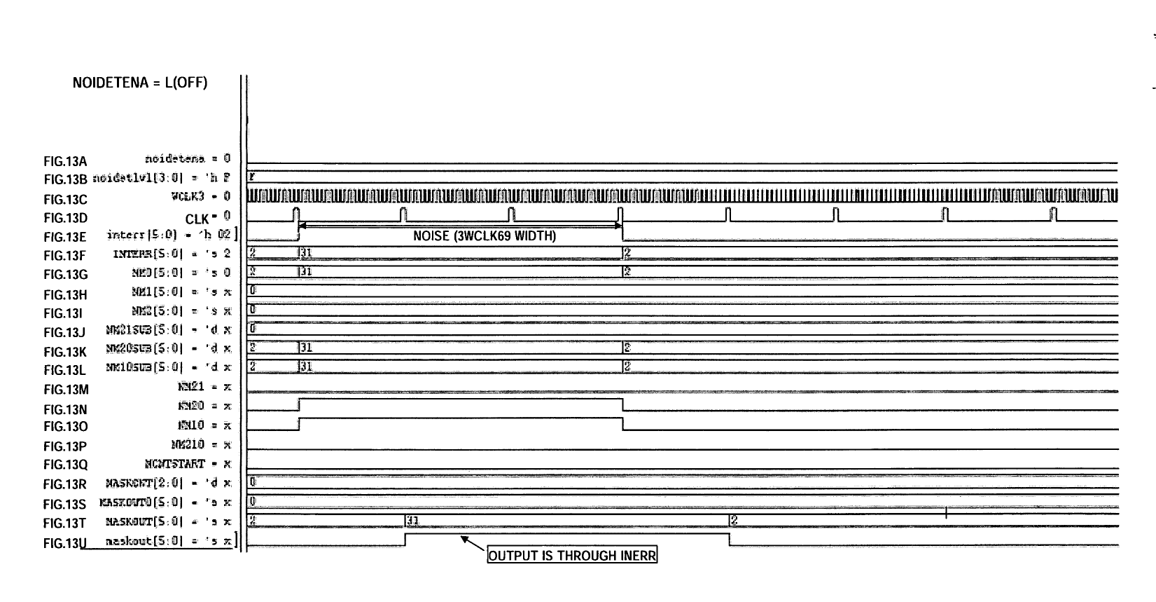

FIGS. 13A to 13U are timing charts in detecting the adjoining level when the noise width is 3WCLK69, specifically, the timing chart in the case where the one bit of the noise detect enable value NOIDETENA is set to the low level (L).

In this case, for example, the one-bit of the noise detect enable value NOIDETENA set to a not shown resistor is set to the low level, so that the switch circuit 2241 selects the signal NM0 of the input phase error difference INERR and outputs it as a signal MASKOUT to the latch circuit 2233.

According to the present embodiment described above, the wobble PLL circuit 22 is provided with the modulation and defect detector 223 measuring a fluctuation between the adjoining cycle or a fluctuation of the one cycle interval of the output of the phase comparator 222 and, if the value exceeds the predetermined threshold value NOIDETLVL, assuming the modulation portion or the defect and masking the feedback signal output from the phase comparator to the VCO. Consequently, the following results are obtained.

By measuring the fluctuation of the phase comparison output in the wobble PLL circuit, the abnormal state can be detected to mask the feedback signal even if pulling-in the phase of the PLL or locking the phase. Consequently, the smooth pull-in can be realized in the pulling-in operation and the fluctuation of the clock phase can be prevented in the locking operation.

If there is the cross-talk of the modulation signal from the adjoining track due to the tracking or focus state, the abnormal of the phase comparison output can be detected and masked.

If the detection of the defect detection circuit delays with respect to the fluctuation of the wobble signal due to a defocus, the phase comparison output can be masked rapidly and the fluctuation of the clock phase with respect to the wobble signal can be prevented.

The wobble signal wave signal is sampled by the ADC then the digital data is used for calculation, as a result the phase error signal can be masked by the PLL performing the phase comparison.

It should be understood by those skilled in the art that various modifications, combinations, sub-combinations and alterations may occur depending on design requirements and other factors in so far as they are within scope of the appeared claims or the equivalents thereof.

What is claimed is:

1. A clock generation circuit for generating a clock used for synchronization with a frequency of a carrier signal, from a signal generated by embedding another wave signal having a predetermined length into a reference carrier signal having a predetermined period, said clock generation circuit comprising:
a sampling circuit for sampling the signal at a phase defined the generated clock; and
a phase locked loop circuit,
wherein said phase locked loop circuit includes
an oscillation circuit for generating a clock oscillating at a frequency corresponding to a phase comparison result and outputting it to said sampling circuit,
a phase comparator for comparing phases of an output signal of said sampling circuit and the oscillation clock of the oscillation circuit and outputting the phase comparison result, and
a detector for detecting a fluctuation of the output signal of the phase comparator and, if the fluctuation exceeding a set threshold value appears, masking a feedback signal which is the phase comparison result, to the oscillation circuit for that period.

2. A clock generation circuit as set forth in claim 1, wherein the detector measures the fluctuation between adjoining cycles or the fluctuation of an one cycle interval included in the output signal from the phase comparator, and, if the measurement value exceeds the set threshold value, masks the feedback signal output from the phase comparator to the oscillation circuit.

3. A clock generation circuit as set forth in claim 1, wherein the detector does not mask and feedbacks the phase comparison result of the phase comparator to the oscillation circuit, in response to the set signal, if the detection result to be masked is obtained.

4. A clock generation circuit as set forth in claim 1, wherein the set threshold can be change to any value.

5. An optical disk apparatus having a wobble and modulating a part of the wobble to record a predetermined information, said optical disk apparatus comprising:
a wobble data generation circuit for generating wobble data on the bases of a reproduction signal corresponding to the reflection light obtained by irradiating light to an optical disk; and
a wobble clock generation circuit having a phase locked loop circuit and generating a wobble clock on the bases of the wobble data generated by said wobble data generation circuit,
wherein said wobble data generation circuit includes
a sampling circuit for sampling the signal including the wobble data generated by said wobble data generation circuit at a phase defined the generated wobble clock,
wherein the phase locked loop circuit includes
an oscillation circuit for generating a clock oscillating at a frequency corresponding to a phase comparison result and outputting it to said sampling circuit,
a phase comparator for comparing phases of a output signal of said sampling circuit and the oscillation clock of the oscillation circuit and outputting the phase comparison result, and
a detector for detecting a fluctuation of the output signal of the phase comparator and, if the fluctuation exceeding a set threshold value appears, masking a feedback signal which is the phase comparison result to the oscillation circuit for that period.

6. An optical disk apparatus as set forth in claim 5, wherein the detector measures the fluctuation between the adjoining cycles or the fluctuation of a one cycle interval included in the output signal of the phase comparator, and masks the feedback signal output from the phase comparator to the oscillation circuit, if the measurement value exceeds the set threshold value.

7. An optical disk apparatus as set forth in claim 5, wherein the detector does not mask and feedbacks the phase comparison result of the phase comparator to the oscillation circuit, in response to the set signal, if the detection result to be masked is obtained.

8. An optical disk apparatus as set forth in claim 5, wherein:
a part of the signal read out from the wobble is performed with an MSK modulation and
the mask duration of the detector is set to four wobble cycle length.

9. An optical disk apparatus as set forth in claim 5, wherein:
a part of the signal read out from the wobble is performed with an MSK modulation and
the mask duration of the detector is set to four wobble cycle length.

10. An optical disk apparatus as set forth in claim 5, wherein the set threshold can be change to any value.
